(19) United States
(12) Patent Application Publication
(10) Pub. No.: US 2018/0180840 A1
(43) Pub. Date: Jun. 28, 2018

(54) FOCUS DEVICE, IMAGING SYSTEM, AND METHOD OF OUTPUTTING FOCUS DRIVE SIGNAL

(71) Applicant: FUJIFILM Corporation, Tokyo (JP)

(72) Inventor: Tetsu WADA, Saitama (JP)

(73) Assignee: FUJIFILM Corporation, Tokyo (JP)

(21) Appl. No.: 15/901,894

(22) Filed: Feb. 22, 2018

Related U.S. Application Data
(63) Continuation of application No. PCT/JP2016/071892, filed on Jul. 26, 2016.

(30) Foreign Application Priority Data
Sep. 16, 2015 (JP) 2015-183083

(51) Int. Cl. G02B 7/28; G03B 13/36; G03B 9/02; G03B 11/00; G02B 27/10; G02B 27/14; G02B 5/20; G02B 5/26

(52) U.S. Cl. CPC G02B 7/28; G03B 13/36; G03B 9/02; G03B 11/00; H04N 5/3696; G02B 27/141; G02B 5/208; G02B 5/26; G02B 27/1013

(57) ABSTRACT

The present invention provides a focus device, an imaging system, and a method of outputting a focus-lens drive signal each capable of securing the amount of infrared rays incident on a focus sensor. Visible rays and infrared rays included in the incidence rays are transmitted through a first region of a diaphragm and the infrared rays are transmitted through a second region of the diaphragm. The visible rays are transmitted through a dichroic mirror, and are incident on an image sensor. The infrared rays are reflected by a reflection surface of the dichroic mirror, and are incident on a focus sensor. A focus-lens drive signal is output from the focus sensor, and is input to a focus-lens drive unit. A focus lens is driven by the focus-lens drive unit. The amount of rays incident on the focus sensor is not decreased, and hence precise focusing can be performed.

### CROSS-REFERENCE TO RELATED APPLICATIONS

This application is a Continuation of PCT International Application No. PCT/JP2016/071892 filed on Jul. 26, 2016, which claims priority under 35 U.S.C. § 119(a) to Japanese Patent Application No. 2015-183083 filed on Sep. 16, 2015. Each of the above application(s) is hereby expressly incorporated by reference, in its entirety, into the present application.

### BACKGROUND OF THE INVENTION

### 1. Field of the Invention

The present invention relates to a focus device, an imaging system, and a method of outputting a focus-lens drive signal.

### 2. Description of the Related Art

For an autofocus, there is provided a structure that separates part of rays incident on an image taking lens and causes the separated rays to be incident on a focus sensor that is different from a sensor for imaging (JP2008-233896A). In such an autofocus, the rays may not be incident on the focus sensor in a case of a certain diaphragm amount or larger. To prevent this, there is provided a structure that separates visible rays and infrared rays from one another, causes the visible rays to be incident on a sensor for imaging, and causes the infrared rays to be incident on a focus sensor (JP2004-118141A). Also, a movable diaphragm that cuts rays with wavelengths in a visible ray region and transmits rays with wavelengths in a near infrared ray region is being considered (JP2013-156605A). Further, a diaphragm whose aperture shape is an elongated shape corresponding to a pupil division direction (JP2013-68819A), a diaphragm further having a region that is formed at the outer side of a light shielding part and that transmits visible rays (JP2007-312311A) are being considered.

### SUMMARY OF THE INVENTION

With the inventions described in JP2004-118141A and JP2013-156605A, the amount of the infrared rays to be obtained is decreased when the aperture of the diaphragm is narrowed. The amount of the infrared rays required for focusing cannot be secured.

It is an object of the present invention to secure the amount of infrared rays required for focusing even when incidence rays are separated into visible rays and infrared rays and focusing is performed by using the infrared rays.

A focus device according to the present invention includes a diaphragm that has a first region having a characteristic of transmitting both visible rays and infrared rays, and a second region having a characteristic of transmitting the infrared rays but cutting the visible rays; a separating unit that separates the visible rays and the infrared rays transmitted through the diaphragm from one another; a focus sensor that receives the infrared rays separated by the separating unit and being incident on a light receiving surface of the focus sensor, and outputs a focus-lens drive signal; and wherein the diaphragm has a third region having a characteristic of cutting the infrared rays and having a characteristic of semi-transmitting the visible rays.

The present invention also provides a method of outputting a focus-lens drive signal by a focus device including a diaphragm having a plurality of optical characteristic regions, separating unit that separates rays transmitted through the diaphragm, and a focus sensor that outputs a focus-lens drive signal. That is, in this method, the separating unit separates visible rays and infrared rays transmitted through the diaphragm from one another, the diaphragm having a first region having a characteristic of transmitting both the visible rays and the infrared rays, and a second region having a characteristic of transmitting the infrared rays but cutting the visible rays, and a third region having a characteristic of cutting the infrared rays and having a characteristic of semi-transmitting the visible rays; and the focus sensor receives the infrared rays separated by the separating unit and being incident on a light receiving surface of the focus sensor, and outputs the focus-lens drive signal.

The diaphragm preferably has a third region having a characteristic of cutting the infrared rays and having a characteristic of semi-transmitting the visible rays.

The third region may have a transmittance for the visible rays, the transmittance being decreased toward an outer peripheral portion of the third region.

The second region and the light receiving surface of the focus sensor have, for example, shapes having long-side directions and short-side directions. In this case, the long-side direction of the second region preferably corresponds to the long-side direction of the light receiving surface of the focus sensor, or the short-side direction of the second region preferably corresponds to the short-side direction of the light receiving surface of the focus sensor.

The second region may be circumscribed on the first region. Also, the third region may be divided by the second region.

A size of the first region in the diaphragm may be changed, and a size of the second region in the diaphragm may be changed.

The visible rays separated by the separating unit may be caused to be incident on a light receiving surface of an imaging device.

A focus-lens drive unit that receives the focus-lens drive signal output from the focus sensor and drives the focus lens may be further included.

An imaging system including the focus device may be provided.

With the invention, the diaphragm has the first region having the characteristic of transmitting both the visible rays and the infrared rays, and the second region having the characteristic of transmitting the infrared rays but cutting the visible rays. The visible rays and the infrared rays transmitted through the diaphragm are separated from one another by the separating unit. The infrared rays are incident on the light receiving surface of the focus sensor. The infrared rays are transmitted through not only the first region, but also the second region. Accordingly, the infrared rays incident on the light receiving surface of the focus sensor can be secured by a large amount. Part of the visible rays is separated for the focus sensor and the amount of the visible rays for the focus sensor is small. Accordingly, the amount of the visible rays for imaging can be prevented from being markedly decreased.

### BRIEF DESCRIPTION OF THE DRAWINGS

FIG. 1 is a block diagram illustrating a configuration of a television lens system;

FIG. 2 illustrates an example of a diaphragm;

FIG. 3 illustrates an example of a diaphragm;

FIG. 4 illustrates an example of a diaphragm;

FIG. 5 illustrates a positional relationship among a diaphragm, a dichroic mirror, and a focus sensor;

FIG. 6 illustrates a positional relationship between the diaphragm and the focus sensor;

FIG. 7 illustrates an example of aperture leaf blades configuring a diaphragm;

FIG. 8 illustrates the example of the aperture leaf blades configuring the diaphragm;

FIG. 9 illustrates an example of the diaphragm;

FIG. 10 illustrates an example of aperture leaf blades configuring a diaphragm;

FIG. 11 illustrates an example of the diaphragm;

FIG. 12 illustrates an example of a diaphragm;

FIG. 13 illustrates an example of aperture leaf blades configuring a diaphragm;

FIG. 14 illustrates an example of the diaphragm; and

FIG. 15 illustrates an example of the diaphragm.

### DESCRIPTION OF THE PREFERRED EMBODIMENTS

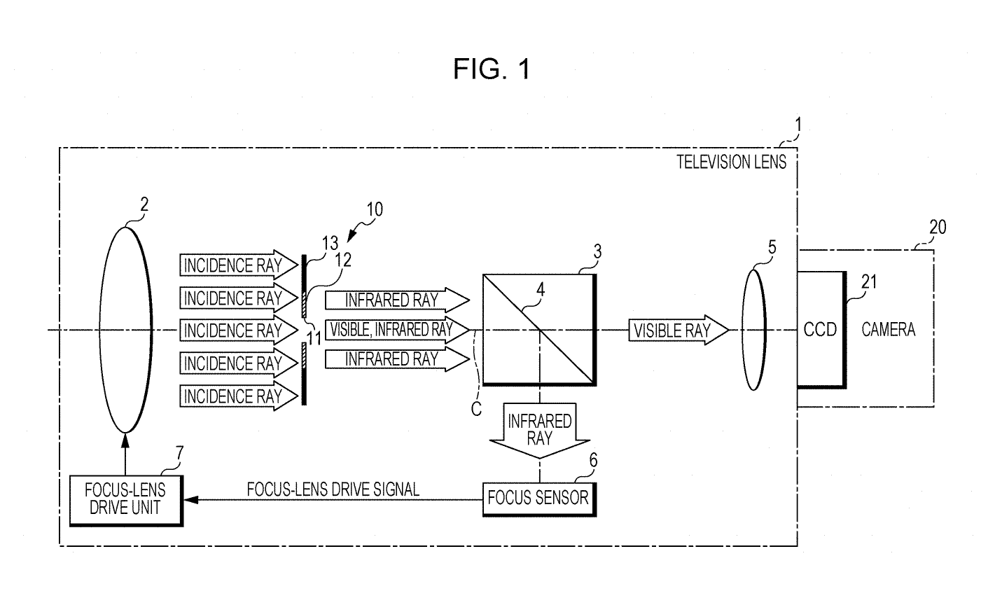

FIG. 1 illustrates an embodiment of the present invention, and is a block diagram illustrating a configuration of a television lens system (an imaging system including a focus device). The embodiment of the television lens system is described below; however, the present invention can be also applied to another imaging system, such as a monitoring camera, a digital still camera, or a movie digital camera.

The television lens system includes a television lens 1 and a camera 20. The television lens 1 is attached to the camera 20.

Incidence rays on the television lens 1 are concentrated and guided to a diaphragm 10 by a focus lens 2.

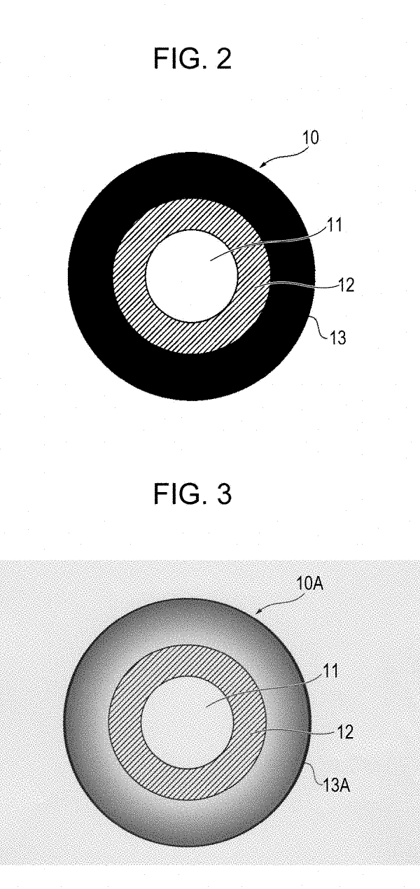

FIG. 2 is a front view of the diaphragm 10.

The diaphragm 10 is a fixed diaphragm whose diaphragm value is fixed. However, a structure to be used as the diaphragm is not limited to the fixed diaphragm, and a variable diaphragm whose diaphragm value is variable may be used, which will be described later. The diaphragm 10 is not limited to an aperture stop whose aperture determines the diaphragm value, and may be a flare stop that cuts unnecessary rays.

A circular first region 11 is formed at the center of the diaphragm 10. The first region 11 is an opening, and the diaphragm value is determined in accordance with the size of the opening. Incidence rays on the television lens 1 include infrared rays in addition to visible rays. The first region 11 has a characteristic of transmitting both the visible rays and the infrared rays. A ring-shaped second region 12 is formed in a manner circumscribed on the first region 11. The second region has a characteristic of transmitting the infrared rays but cutting the visible rays. Further, a ring-shaped third region 13 is formed in a manner circumscribed on the second region 12. The third region 13 has a characteristic of cutting both the visible rays and the infrared rays. While the third region 13 is formed in the diaphragm 10, the third region 13 does not have to be formed. The centers of the first region 11, second region 12, and third region 13 correspond to an optical axis C of the television lens 1.

Referring back to FIG. 1, the first region 11 of the diaphragm 10 transmits the visible rays and the infrared rays, the second region 12 of the diaphragm 10 transmits the infrared rays (cuts the visible rays), and the third region 13 of the diaphragm 10 cuts both the visible rays and the infrared rays. The visible rays and the infrared rays transmitted through the diaphragm 10 are guided to a dichroic mirror 3 (a separating unit). The infrared rays are reflected by a reflection surface 4 of the dichroic mirror 3. The visible rays are transmitted through the reflection surface 4 of the dichroic mirror 3. In this way, the rays transmitted through the diaphragm 10 are separated into the visible rays and the infrared rays by the dichroic mirror 3. Part of the visible rays and infrared rays may be reflected by the reflection surface 4 depending on the wavelength characteristics of the dichroic mirror 3.

The television lens 1 according to the embodiment can position the focus lens 2 by phase difference autofocus (AF). Hence, the television lens 1 includes a focus sensor 6. The infrared rays reflected by the reflection surface 4 of the dichroic mirror 3 are divided into two by an optical system (not illustrated). The infrared rays divided into two are incident on the focus sensor 6, and the focus sensor 6 outputs a focus-lens drive signal for driving the focus lens 2 on the basis of the distance between two subject images formed on the focus sensor 6. The focus-lens drive signal is input to a focus-lens drive unit 7. The focus lens 2 is driven by the focus-lens drive unit 7.

Since the infrared rays transmitted through the first region 11 and the second region 12 of the diaphragm 10 are incident on the focus sensor 6, it is not necessary to cause part of the visible rays to be incident on the focus sensor 6, and form the focus-lens drive signal. Hence, even when the aperture amount of the diaphragm 10 is small, a phenomenon in which the visible rays are not incident on the focus sensor 6 and precise focusing cannot be performed is prevented from occurring. Also, since the infrared rays are incident on the focus sensor 6, as compared with a case where part of the visible rays is separated and caused to be incident on the focus sensor 6, the amount of the visible rays that are incident on an image sensor 21, such as a charge-coupled device (CCD) sensor or a complementary metal-oxide semiconductor (CMOS) sensor, is not decreased, and hence a subject image that is imaged is prevented from being dark. Also, since the infrared rays transmitted through the second region 12, in addition to the infrared rays transmitted through the first region 11 of the diaphragm 10, are incident on the focus sensor 6 and form a focus-lens drive signal, the amount of the infrared rays incident on the focus sensor 6 is further increased by the amount of the infrared rays transmitted through the first region 11 of the diaphragm 10. Even when the aperture amount of the diaphragm 10 is small, the amount of the infrared rays incident on the focus sensor 6 is prevented from being insufficient, and focusing can be relatively precisely performed.

The diaphragm 10, the dichroic mirror 3, and the focus sensor 6 configure a focus device.

The visible rays transmitted through the reflection surface 4 of the dichroic mirror 3 are guided by an imaging lens 5 to a light receiving surface of the image sensor 21 (imaging device) included in the camera 20. The image sensor 21 outputs video signals representing a subject image.

FIG. 3 is a front view of another example of a diaphragm.

A diaphragm 10A illustrated in FIG. 3 can be used in the television lens system illustrated in FIG. 1, instead of the diaphragm 10 illustrated in FIG. 2.

In the diaphragm 10A illustrated in FIG. 3, a circular first region 11 is formed at the center, and a ring-shaped second region 12 is formed in a manner circumscribed on the first region 11, similarly to the diaphragm 10 illustrated in FIG. 2. The first region 11 transmits visible rays and infrared rays. The second region 12 cuts the visible rays but transmits the infrared rays. Further, a ring-shaped third region 13A is formed in a manner circumscribed on the second region 12. The third region 13A has a semi-transmission characteristic for the visible rays. Since the visible rays transmitted through the third region 13A are guided to the image sensor 21, the resulting subject image has blurriness in a natural manner. The third region 13A illustrated in FIG. 3 has a transmittance for the visible rays that is decreased toward an outer peripheral portion of the third region 13A. However, the transmittance for the visible rays does not have to be decreased toward the outer peripheral portion of the third region 13A.

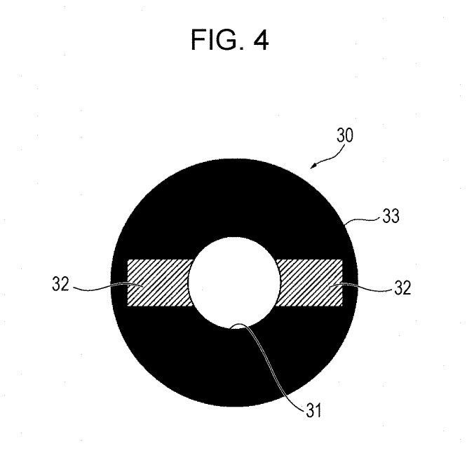

FIG. 4 is a front view illustrating another example of a diaphragm.

A diaphragm 30 illustrated in FIG. 4 can be used in the television lens system illustrated in FIG. 1, instead of the diaphragm 10 illustrated in FIG. 2.

Similarly to the diaphragm 10 illustrated in FIG. 2, a circular first region 31 is formed at the center of the diaphragm 30 illustrated in FIG. 4. The first region 31 is an opening, and transmits both visible rays and infrared rays. A rectangular second region 32 is formed in a lateral direction (lateral direction in FIG. 4) from the first region 31. The second region 32 has a characteristic of cutting the visible rays but transmitting the infrared rays. The residual region of the diaphragm 30 other than the first region 31 and the second region 32 is a third region 33 having a characteristic of cutting both the visible rays and the infrared rays.

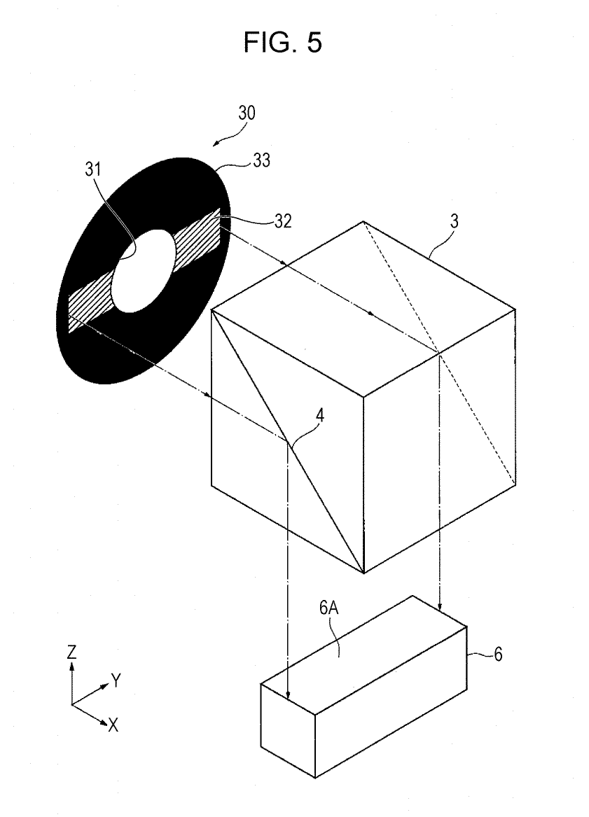

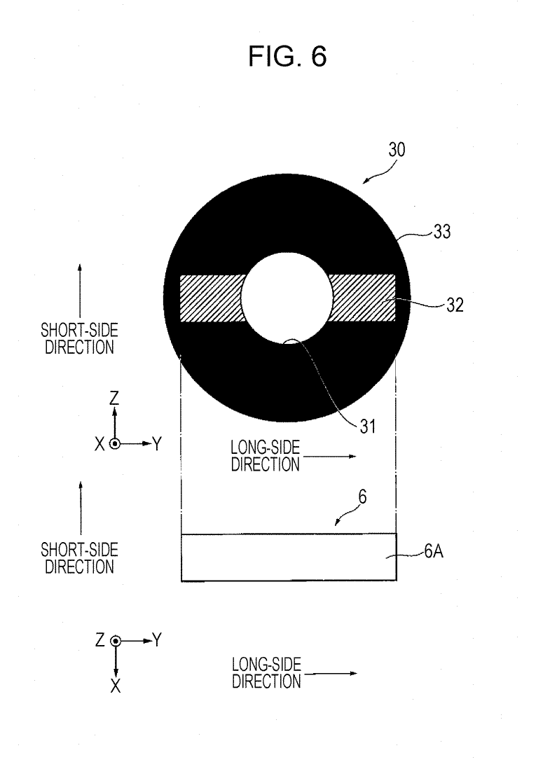

FIG. 5 illustrates a positional relationship among the diaphragm 30, the dichroic mirror 3, and the focus sensor 6 when the diaphragm 30 is applied to the television lens system illustrated in FIG. 1. FIG. 6 provides a rear view (equivalent to the front view) of the diaphragm 30, and a plan view of the focus sensor 6.

In FIG. 5, it is assumed that a direction being the same as the optical axis C of the television lens 1 defines an X direction, and a right angle formed with respect to the X direction define a Y direction and a Z direction.

As illustrated in FIG. 6, the second region 32 of the diaphragm 30, and a light receiving surface 6A of the focus sensor 6 both have shapes having long-side directions and short-side directions. As illustrated in FIGS. 5 and 6, the long-side direction of the light receiving surface 6A of the focus sensor 6 is the Y direction, and the long-side direction of the second region 32 of the diaphragm 30 is also the Y direction. In this way, the focus sensor 6 and the diaphragm 30 are configured in the television lens system so that the long-side direction of the light receiving surface 6A of the focus sensor 6 (the focus sensor 6) corresponds to the long-side direction of the second region 32 of the diaphragm 30 (the long-side directions do not have to completely correspond to one another and may substantially apparently correspond to one another, for example, the angle defined by both the long-side directions is 10 degrees or smaller). The amount of the infrared rays incident on the light receiving surface 6A of the focus sensor 6, included in the infrared rays transmitted through the second region 32, is increased.

In the example in FIG. 5, the diaphragm 30 and the focus sensor 6 are configured so that the long-side direction of the light receiving surface 6A of the focus sensor 6 (the focus sensor 6) corresponds to the long-side direction of the second region 32 of the diaphragm 30. However, the diaphragm 30 and the focus sensor 6 may be configured so that the short-side direction of the light receiving surface 6A of the focus sensor 6 (the focus sensor 6) corresponds to the short-side direction of the second region 32 of the diaphragm 30 (the short-side directions do not have to completely correspond to one another and may substantially apparently correspond to one another). In the example illustrated in FIG. 5, when the focus sensor 6 is rotated in an XY plane by 90 degrees and the diaphragm 30 is rotated in a YZ plane by 90 degrees, the short-side direction of the light receiving surface 6A of the focus sensor 6 (the focus sensor 6) corresponds to the short-side direction of the second region 32 of the diaphragm 30.

In the example illustrated in FIGS. 5 and 6, it may be considered that the shape of the second region 32 is similar to the shape of the focus sensor 6 (the light receiving surface 6A of the focus sensor 6). However, the shape of the second region 32 and the shape of the focus sensor 6 (the light receiving surface 6A of the focus sensor 6) may be similar to one another, or may be different from one another. For example, the shape of the second region 32 may be ellipsoidal. The shape of the second region 32 and the shape of the focus sensor 6 (the light receiving surface 6A of the focus sensor 6) may be any shapes as long as the shapes have long-side directions and short-side directions. The lengths in the long-side directions may be the same as the lengths in the short-side directions.

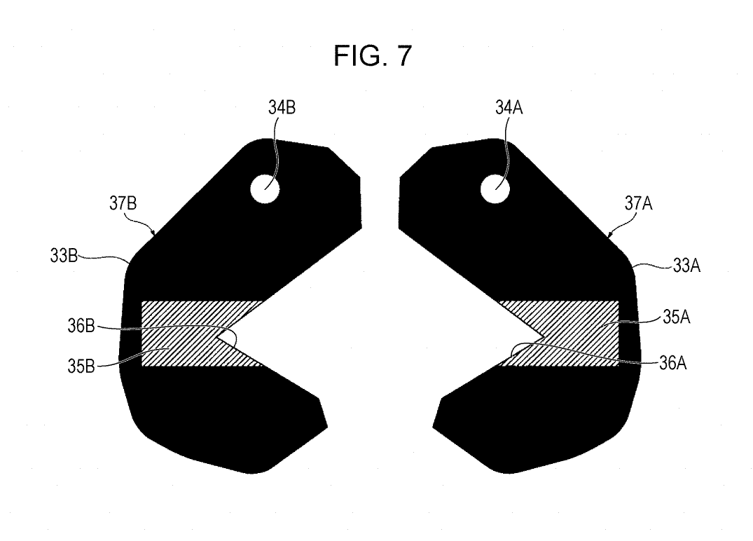

FIGS. 7 to 9 illustrate another embodiment.

While the state in which the size of the first region 11 is fixed and the diaphragm value is not changed has been described in the above-described embodiment, a case in which the diaphragm value is changed is described in the embodiment illustrated in FIGS. 7 to 9.

FIGS. 7 to 9 illustrate a diaphragm 37 of two leaf blades.

FIG. 7 is an exploded view of the diaphragm 37.

The diaphragm 37 is composed of a first aperture leaf blade 37A and a second aperture leaf blade 37B.

The first aperture leaf blade 37A is bent inward. A hole 34A is made in one end portion of the first aperture leaf blade 37A. An infrared-ray transmitting region 35A that cuts the visible rays but transmits the infrared rays is formed at a bent portion. The residual region other than the infrared-ray transmitting region 35A is a light shielding region 33A that cuts both the visible rays and the infrared rays.

The second aperture leaf blade 37B is also bent inward. A hole 34B is also made in one end portion of the second aperture leaf blade 37B. An infrared-ray transmitting region 35B that cuts the visible rays but transmits the infrared rays is formed at a bent portion. The residual region other than the infrared-ray transmitting region 35B is a light shielding region 33B that cuts both the visible rays and the infrared rays.

The first aperture leaf blade 37A and the second aperture leaf blade 37B are fastened to one another in a manner that the hole 34A and the 34B are aligned with one another by a pin (not illustrated) rotatably by predetermined angles around the pin.

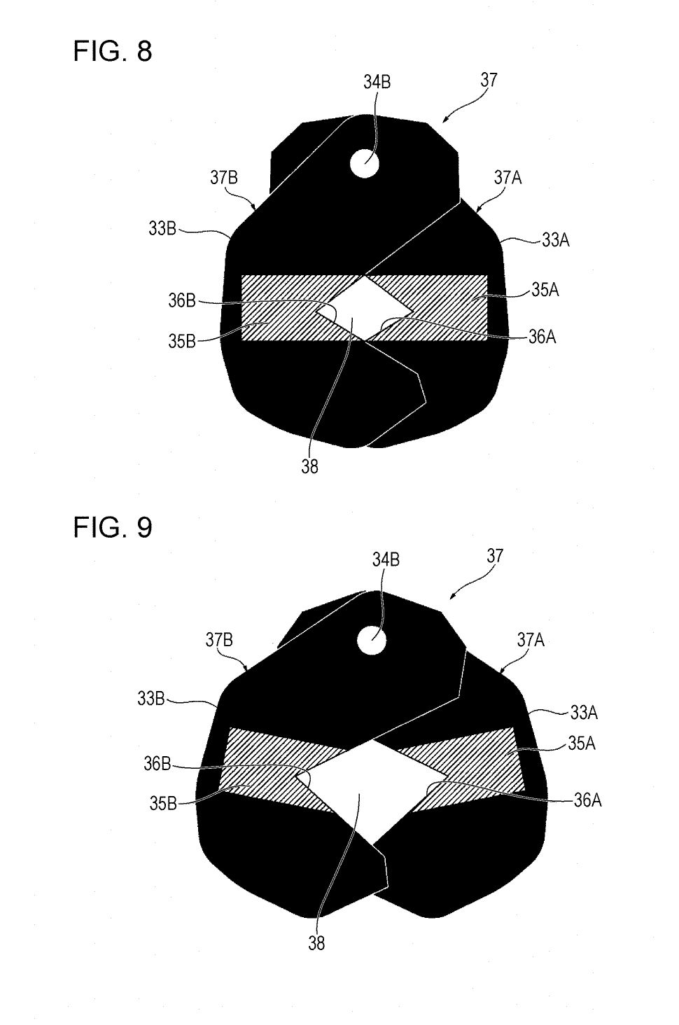

FIG. 8 illustrates the state in which the first aperture leaf blade 37A and the second aperture leaf blade 37B are fastened to one another by the pin.

A region defined by a side 36A at the inner side of the infrared-ray transmitting region 35A of the first aperture leaf blade 37A and a side 36B at the inner side of the infrared-ray transmitting region 35B of the second aperture leaf blade 37B is an opening portion, and the opening portion serves as a first region 38 (corresponding to the first region 31 of the diaphragm 30 illustrated in FIG. 4) that transmits both the visible rays and the infrared rays. A region in which the infrared-ray transmitting region 35A of the first aperture leaf blade 37A is combined with the infrared-ray transmitting region 35B of the second aperture leaf blade 37B serves as a second region (corresponding to the second region 32 of the diaphragm 30 illustrated in FIG. 4) that cuts the visible rays but transmits the infrared rays. A region in which the light shielding region 33A of the first aperture leaf blade 37A is combined with the light shielding region 33B of the second aperture leaf blade 37B serves as a third region (corresponding to the third region 33 of the diaphragm 30 illustrated in FIG. 4) that cuts both the visible rays and the infrared rays.

FIG. 9 illustrates a state of the diaphragm 37 in which the first aperture leaf blade 37A and the second aperture leaf blade 37B are rotated outward by predetermined angles around the pin (not illustrated) inserted into the holes 34A and 34B. By rotating the first aperture leaf blade 37A and the second aperture leaf blade 37B around the pin to move toward one another, the size of the first region 38 is decreased. By rotating the first aperture leaf blade 37A and the second aperture leaf blade 37B around the pin to move away from one another, the size of the first region 38 is increased. Accordingly, the size of the first region 38 can be changed.

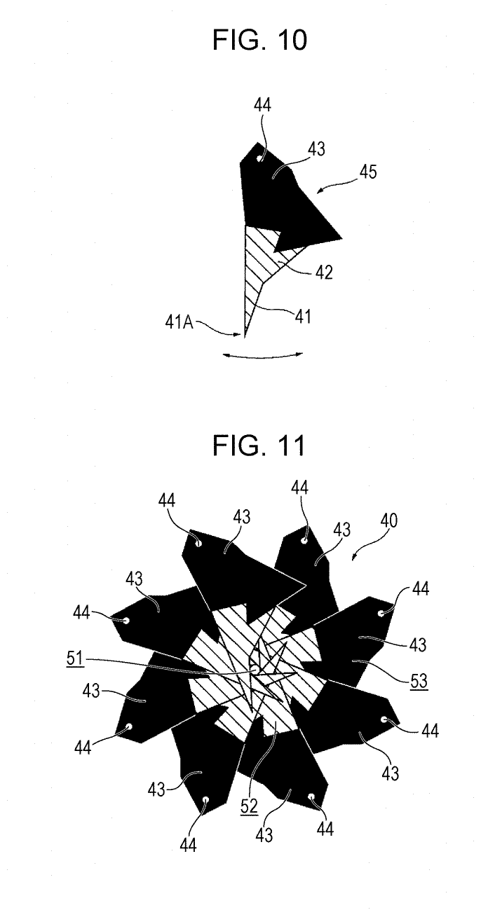

FIGS. 10 and 11 illustrate another example of a diaphragm whose diaphragm value can be changed, which is an example of a diaphragm 40 of eight leaf blades.

FIG. 10 is a front view of an aperture leaf blade 45 configuring the diaphragm.

The aperture leaf blade 45 has a pin 44 attached thereto at a position near a vertex thereof. The aperture leaf blade 45 is rotatable around the pin 44 only by an angle corresponding to the diaphragm value.

A substantially half region (upper half region in FIG. 10) of the aperture leaf blade 45 is a light shielding region 43 that cuts both visible rays and infrared rays. The residual substantially half region (lower half region in FIG. 10) of the aperture leaf blade 45 is an infrared-ray transmitting region 42 that cuts the visible rays but transmits the infrared rays. A partial side 41 that defines the infrared-ray transmitting region 42 defines a first region 51 (see FIG. 11) of an opening that determines a diaphragm amount (described later).

Referring to FIG. 11, the diaphragm 40 is configured by fixing the pins 44 of the eight aperture leaf blades 45 at equivalent intervals on the same circumference. An opening whose size is determined by the partial sides 41 is formed at the center, and the opening serves as a first region 51. The first region 51 transmits both the visible rays and the infrared rays. A region defined by the infrared-ray transmitting regions 42 of the eight aperture leaf blades 45 serves as a second region 52. The second region 52 transmits the infrared rays but cuts the visible rays. A region defined by the light shielding regions 43 of the eight aperture leaf blades 45 serves as a third region 53. The third region 53 cuts both the visible rays and the infrared rays.

When the aperture leaf blades 45 are rotated around the pins 44 (rotated leftward around the pins 44) so that vertices 41A (see FIG. 10) configuring the partial sides 41 of the aperture leaf blades 45 move toward the center of the diaphragm 40, the size of the first region 51 is decreased (the size of the opening is decreased), and the size of the second region 52 is also decreased. In contrast, when the aperture leaf blades 45 are rotated around the pins 44 (rotated rightward around the pins 44) so that the vertices 41A (see FIG. 10) configuring the partial sides 41 of the aperture leaf blades 45 move away from the center of the diaphragm 40, the size of the first region 51 is increased (the size of the opening is increased), and the size of the second region 52 is also increased. Accordingly, the size of the first region 51 and the size of the second region 52 can be changed.

The diaphragm 37 and the diaphragm 40 each can be applied to the television lens system instead of the diaphragm 10 illustrated in FIG. 1.

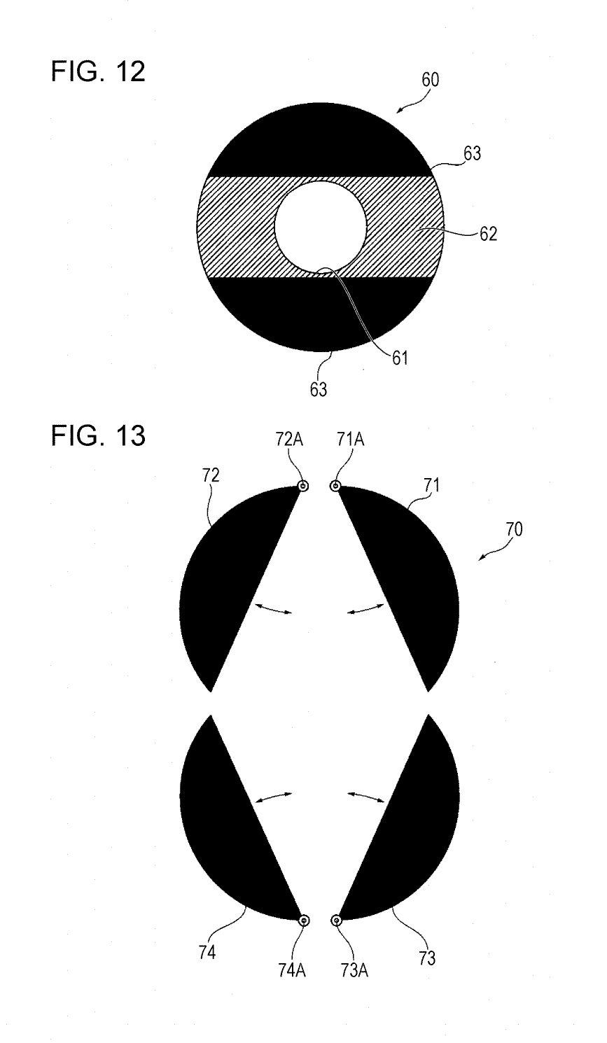

FIG. 12 illustrates an example of another diaphragm.

A first region 61 that transmits visible rays and infrared rays is defined at the center of a diaphragm 60. A second region 62 is defined in a lateral direction (lateral direction in FIG. 12) of the first region 61 so as to surround the first region 61. The second region 62 has a characteristic of cutting the visible rays but transmitting the infrared rays. Third regions 63 are defined above and below the second region 62. The third region 63 has a characteristic of cutting both the visible rays and the infrared rays. The third regions 63 are divided by the second region 62. Even with the diaphragm 60 having such a structure, a relatively large amount of the infrared rays can be incident on the light receiving surface 6A of the focus sensor 6.

FIGS. 13 to 15 illustrate another example of a diaphragm. A diaphragm 70 illustrated in FIGS. 13 to 15 can be applied to the television lens system, instead of the diaphragm 10 illustrated in FIG. 1.

The diaphragm 70 illustrated in FIGS. 13 to 15 uses a first aperture leaf blade 71, a second aperture leaf blade 72, a third aperture leaf blade 73, and a fourth aperture leaf blade 74. The four aperture leaf blades 71 to 74 each have a fan shape.

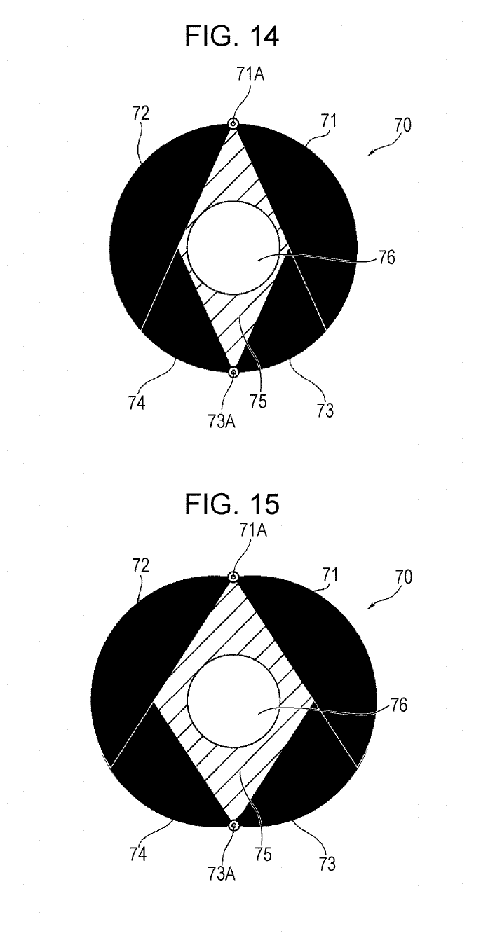

Referring to FIG. 13, the first aperture leaf blade 71, the second aperture leaf blade 72, the third aperture leaf blade 73, and the fourth aperture leaf blade 74 respectively have holes 71A, 72A, 73A, and 74A each formed at one of two corners of the corresponding aperture leaf blade. Pins (not illustrated) are inserted into the holes 71A, 72A, 73A, and 74A. The hole 71A of the first aperture leaf blade 71 is aligned with the hole 72A of the second aperture leaf blade 72 so that the outer sides define fan shapes. Likewise, the hole 73A of the third aperture leaf blade 73 is aligned with the hole 74A of the fourth aperture leaf blade 74 so that the outer sides define fan shapes. When a visible-light shielding sheet that has a characteristic of cutting visible rays but transmitting infrared rays and that has an opening at the center is attached to the rear sides of the first aperture leaf blade 71, second aperture leaf blade 72, third aperture leaf blade 73, and fourth aperture leaf blade 74, the diaphragm 70 illustrated in FIG. 14 is obtained.

Referring to FIG. 14, an opening first region 76 appears in an inner region defined by the first aperture leaf blade 71, the second aperture leaf blade 72, the third aperture leaf blade 73, and the fourth aperture leaf blade 74. The first region 76 transmits both the visible rays and the infrared rays. The residual region other than the first region 76 in the inner region defined by the first aperture leaf blade 71, the second aperture leaf blade 72, the third aperture leaf blade 73, and the fourth aperture leaf blade 74 serves as a second region 75. The second region 75 cuts the visible rays but transmits the infrared rays.

The first aperture leaf blade 71 can be rotated by a predetermined angle around the hole 71A. The second aperture leaf blade 72 can be rotated by a predetermined angle around the hole 72A. The third aperture leaf blade 73 can be rotated by a predetermined angle around the hole 73A. The fourth aperture leaf blade 74 can be rotated by a predetermined angle around the hole 74A.

When the first aperture leaf blade 71, the second aperture leaf blade 72, the third aperture leaf blade 73, and the fourth aperture leaf blade 74 are expanded to move away from the center from the state illustrated in FIG. 14, as illustrated in FIG. 15, the size of the second region 75 is increased (changed) while the size of the first region 76 is not changed. Accordingly, the size of the second region 75 can be changed while the size of the first region 76 is not changed. When the first aperture leaf blade 71, the second aperture leaf blade 72, the third aperture leaf blade 73, and the fourth aperture leaf blade 74 are rotated to move toward the center, the size of the first region 76 also becomes smaller than the size illustrated in FIG. 14 or FIG. 15, and hence the size of the first region 76 can be also changed.

For any of the diaphragms illustrated in FIGS. 4 to 15, the third region may have a semi-transmission characteristic for the visible rays, or the transmittance for the visible rays may be decreased toward the outer peripheral portion of the third region like the diaphragm 10A illustrated in FIG. 3.

### REFERENCE SIGNS LIST

1 television lens
3 dichroic mirror (separating unit)
6 focus sensor
7 focus-lens drive unit
10, 10A, 30, 37, 40, 60, 70 diaphragm
11, 31, 51, 61, 76 first region
12, 32, 35A, 35B, 52, 62, 75 second region
13A third region

What is claimed is:

1. A focus device comprising:
a diaphragm that has a first region having a characteristic of transmitting both visible rays and infrared rays, and a second region having a characteristic of transmitting the infrared rays but cutting the visible rays;
a separating unit that separates the visible rays and the infrared rays transmitted through the diaphragm from one another;
a focus sensor that receives the infrared rays separated by the separating unit and being incident on a light receiving surface of the focus sensor, and outputs a focus-lens drive signal; and
wherein the diaphragm has a third region having a characteristic of cutting the infrared rays and having a characteristic of semi-transmitting the visible rays.

2. The focus device according to claim 1,
wherein the third region has a transmittance for the visible rays, the transmittance being decreased toward an outer peripheral portion of the third region.

3. The focus device according to claim 1,
wherein the second region and the light receiving surface of the focus sensor have shapes having long-side directions and short-side directions, and
wherein the long-side direction of the second region corresponds to the long-side direction of the light receiving surface of the focus sensor, or the short-side direction of the second region corresponds to the short-side direction of the light receiving surface of the focus sensor.

4. The focus device according to claim 2,
wherein the second region and the light receiving surface of the focus sensor have shapes having long-side directions and short-side directions, and
wherein the long-side direction of the second region corresponds to the long-side direction of the light receiving surface of the focus sensor, or the short-side direction of the second region corresponds to the short-side direction of the light receiving surface of the focus sensor.

5. The focus device according to claim 3,
wherein the second region is circumscribed on the first region.

6. The focus device according to claim 4,
wherein the second region is circumscribed on the first region.

7. The focus device according to claim 3,
wherein the third region is divided by the second region.

8. The focus device according to claim 4,
wherein the third region is divided by the second region.

9. The focus device according to claim 5,
wherein the third region is divided by the second region.

10. The focus device according to claim 6,
wherein the third region is divided by the second region.

11. The focus device according to claim 1,
wherein a size of the first region in the diaphragm is changed.

12. The focus device according to claim 2,
wherein a size of the first region in the diaphragm is changed.

13. The focus device according to claim 3,
wherein a size of the first region in the diaphragm is changed.

14. The focus device according to claim 4,
wherein a size of the first region in the diaphragm is changed.

15. The focus device according to claim 5,
wherein a size of the first region in the diaphragm is changed.

16. The focus device according to claim 1,
wherein a size of the second region in the diaphragm is changed.

17. The focus device according to claim 1,
wherein the visible rays separated by the separating unit are caused to be incident on a light receiving surface of an imaging device.

18. The focus device according to claim 1, further comprising:
a focus-lens drive unit that receives the focus-lens drive signal output from the focus sensor and drives a focus lens.

19. An imaging system comprising the focus device according to claim 1.

20. A method of outputting a focus-lens drive signal by a focus device comprising a diaphragm having a plurality of optical characteristic regions, separating unit that separates rays transmitted through the diaphragm, and a focus sensor that outputs a focus-lens drive signal,
wherein the separating unit separates visible rays and infrared rays transmitted through the diaphragm from one another, the diaphragm having a first region having a characteristic of transmitting both the visible rays and the infrared rays, and a second region having a characteristic of transmitting the infrared rays but cutting the visible rays, and a third region having a characteristic of cutting the infrared rays and having a characteristic of semi-transmitting the visible rays, and
wherein the focus sensor receives the infrared rays separated by the separating unit and being incident on a light receiving surface of the focus sensor, and outputs the focus-lens drive signal.
